(19) United States
(12) Patent Application Publication
(10) Pub. No.: US 2026/0152110 A1
(43) Pub. Date: Jun. 4, 2026

(54) MATERIAL DELIVERY VEHICLE

(71) Applicant: Jeffrey D. Chesser, Marietta, GA (US)

(72) Inventor: Jeffrey D. Chesser, Marietta, GA (US)

(21) Appl. No.: 19/462,210

(22) Filed: Jan. 28, 2026

Related U.S. Application Data
(63) Continuation-in-part of application No. 18/387,652, filed on Nov. 7, 2023.

(51) Int. Cl. B60P 1/36

(52) U.S. Cl. CPC B60P 1/36

(57) ABSTRACT

A material delivery vehicle includes a chassis, rear wheels, front wheels, and a passenger cab. The vehicle also includes a material bed, a delivery belt system, and an equipment bed. A walking floor type conveyor is positioned over the floor that moves material within the material bed to a position located at the rear of the material bed. The delivery belt system is mounted directly behind the material bed so that material being moved off the conveyor belt falls directly onto the delivery belt system. The delivery belt system has a conveyor belt with a delivery end. The material bed and equipment bed extend beyond the delivery belt system so as to form a notch adjacent to the delivery belt system. The delivery end of the conveyor belt is similarly positioned above or closely adjacent the frame rail associated with the delivery side.

### CROSS REFERENCE TO RELATED APPLICATIONS

This is a continuation-in-part of U.S. patent application Ser. No. 18/387,652 filed Nov. 7, 2023 and entitled MATERIAL DELIVERY VEHICLE.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### FIELD OF THE INVENTION

The 1 invention relates generally to a vehicle for simultaneously delivering top-dressing material, mulch, loose aggregate, and the equipment, tools or machinery necessary to install the material thereby eliminating the necessity to use multiple vehicles or multiple trips.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

1 Today, loose material such as top-dressing gravel, sand, dirt, mulch, and the like are delivered in large trucks. The material is placed in a rear positioned bed where the material may be either pushed out of the rear of the bed or the bed is tilted to gravitationally dump the material from the bed. This type of delivery results in a large pile being produced on the ground adjacent the truck. As such, the material must still be loaded onto wheelbarrows or moved with small front end loaders to move the material to the desired final location. The tilting feature of the container portion of the truck may also be a problem as a tilted container may hit overhanging objects while being tilted or subsequently when driven away should the driver forget that the container is in a tilted position.

Trucks have also been designed to specifically deliver top-dressing material such as mulch or other loose material to a jobsite. These trucks include a material bed that contains the loose material and a material movable tarp that movese the material to the rear of the bed. These trucks also have an endless loop converyor belt positioned adjacent the rear of the bed so that the material being moved to the rear of the bed is dumped onto the conveyor belt. The conveyor belt then moves the material laterally with respect to the truck so that it may be dumped into a wheelbarrow or other transport vehicle to the side of the truck. A problem with this is that the wheelbarrow must be positioned to the side of the truck to catch the material being dumped off the conveyor belt, which can be a problem when the truck is parked on a road used by other passing vehicles. Another problem with these trucks is that the location of the conveyor belt system adds additional weight at the very rear end of the truck, which may cause the truck's weight or center of gravity to shift rearward to an undesired degree.

The background of this invention comes from the observation of existing practices, methods and equipment previously and currently used throughout the topdressing industry. Such observations have led to the desire for a more efficient and economical way to delivery, install and apply top-dressing material and general landscape supply materials to the residential and commercial sector. This novel and improved concept centers around the invention of a vehicle/truck body with a forward material hopper capable of holding, storing and delivering material mechanically into a mid-mount side dispensing apparatus and a rear ‘dove tail” type machinery platform capable of efficiently loading and offloading machinery for transporting and installing dispensed material from forward mount hopper.

Accordingly, it is seen that a need remains for a singular material and equipment delivery truck which provides an efficient manner of deliverying material and necessary installation equipment in a quick yet safe manner. It is to the provision of such therefore that the present invention is primarily directed.

### BRIEF SUMMARY OF THE INVENTION

In a preferred form of the invention, a material delivery vehicle comprises a chassis, a pair of rear wheels, a pair of front wheels, a cab mounted to the chassis, and a material bed having a container portion having a top opening and being removably mounted to the chassis directly behind the cab, a material conveyor positioned within the container portion configured to move material within the container portion rearwardly to a delivery belt system also contained within the container portion, the material bed and its components being self-contained so as to be removable from the chassis.

In another preferred form of the invention, a top-dressing material delivery bin mountable to a vehicle chasses, the top-dressing material delivery bin comprises a material bed having a container portion having a top opening and being removably mountable to a vehicle chassis through mounting plates, a material conveyor positioned within the container portion configured to move material within the container portion rearwardly to a delivery belt system also contained within the container portion, the material bed and its components being self-contained so as to be removable from the chassis.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

1 FIG. 1 is a perspective view of a material delivery vehicle embodying principles of the invention in a preferred form.

FIG. 2 is a schematic side view of the material delivery vehicle of FIG. 1.

FIG. 3 is a schematic top view of the material delivery vehicle of FIG. 1.

FIG. 4 is a perspective view of a material delivery vehicle embodying principles of the invention in another preferred form.

FIG. 5 is a side view of a material delivery vehicle of FIG. 4.

FIG. 6 is a schematic top view of the material delivery vehicle of FIG. 4.

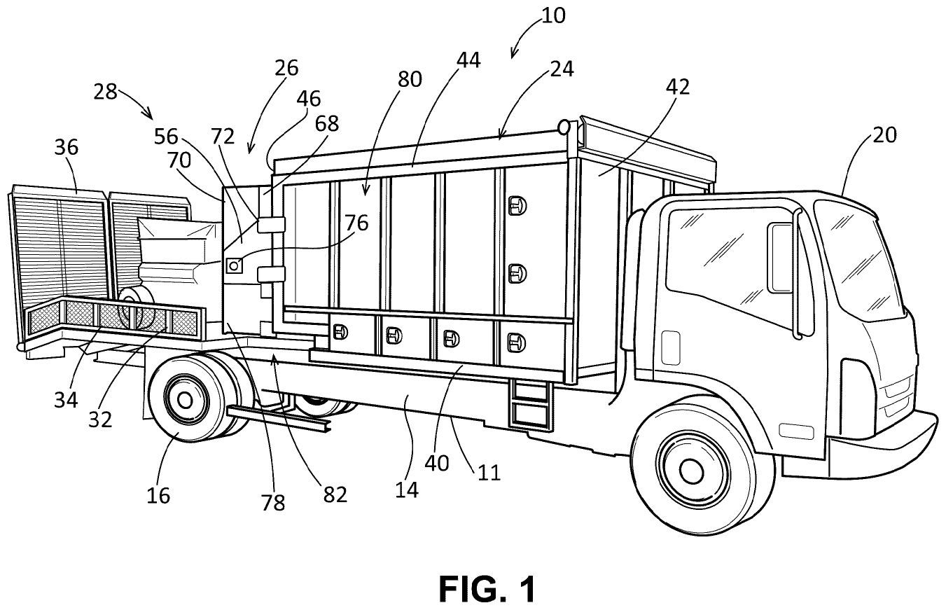

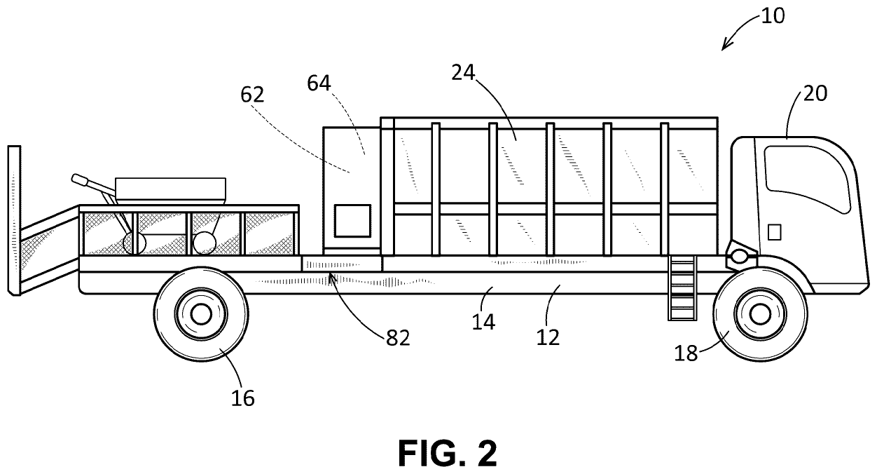

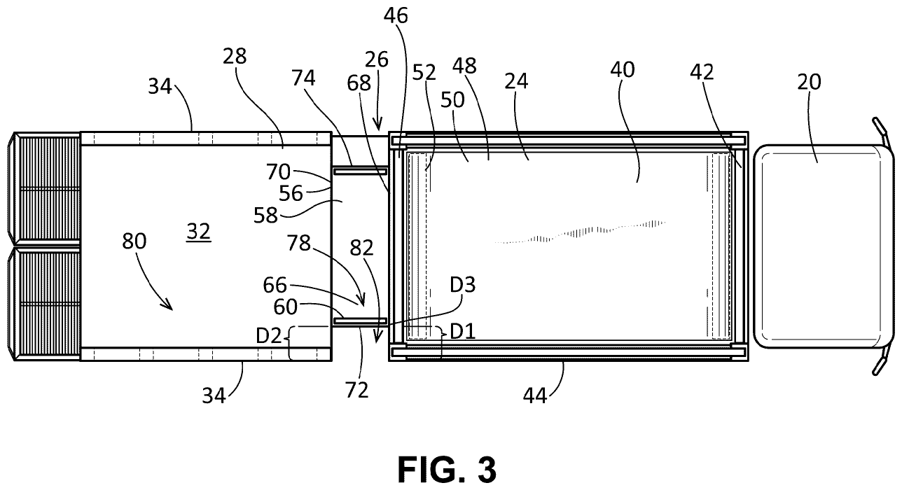

### DETAILED DESCRIPTION OF CERTAIN EMBODIMENTS

With1 reference next to the drawings, there is shown a top-dressing material delivery vehicle 10 according to the present invention in the form of a truck, referenced hereinafter simply as vehicle 10. The vehicle could also be in the form of a trailer.

The vehicle 10 includes a frame or chassis 12 having longitudinal rails or beams 14. The vehicle 10 also includes the typical additional components of a truck, such as rear wheels and suspension 16, a front wheels and suspension 18, unshown rear axle, unshown drivetrain of a motor and transmission, and a passenger cab 20 positioned at the front end of the frame 12. A trailer embodiment would not include the cab or drivetrain of a truck.

The vehicle 10 also includes a material bin or bed 24 mounted to a forward end of the frame 12 directly behind or rearward of the cab 20, a delivery belt system 26 is mounted directly behind or rearward of the material bed 24 and in front of the rear wheels 16, and an equipment bed 28 is mounted directly behind or rearward of the delivery belt system 26. The delivery belt system 26 may be a belted, tarped, an auger, or walking floor system that is coupled to the material bed 24 so as to be capable of moving material to the rear and side of the material bed 24. The forward end represents the front end of the vehicle and its components relative to the vehicle's customary forward direction, while the rearward end is the trailing end opposite from the forward end.

The cab 20 includes all the conventional components such as seats, dashboard, gauges, steering wheel, transmission shifter, etc. The cab 20 is typically positioned over the motor and transmission of the vehicle 10.

The equipment bed 28 includes a floor 32, side walls or rails 34 extending upwardly from the floor 32, and a rear tilting tailgate or ramp 36. The tailgate 36 pivots rearwardly so that equipment may be run up and down the ramp and onto the floor 32 through a position behind the vehicle 10. This positioning eliminates the dangers associated with having a side tilting ramp that encroaches onto pathway of the road. The equipment bed 28 is used to store and transport equipment associated with the loading or distribution of material, such as wheelbarrows, small tractors, lawnmowers, or other construction related equipment.

The material bed 24 is generally an open top container having a floor 40, a front wall 42, two oppositely disposed sidewalls 44, and a rear wall 46. The front wall 42, sidewalls 44, and rear wall 46 all extend upwardly from the floor 40. A walking floor type conveyor 48 is positioned over the floor 40 that moves loose material within the material bed 24 to a position located at the rear of the material bed 24. The conveyor 48 may also be a movable or rollable tarp type system of other moving floor system that moves large amounts of material contained within the material bed 24.

The conveyor 48 includes an endless loop conveyor belt 50 that is rotated through hydraulic or electric motorized rollers 52. The conveyor belt 50 may be a chevron patterned conveyor belt that is specifically designed for moving loose material.

The delivery belt system 26 is mounted directly behind the material bed 24 so that material being moved off the conveyor belt 50 falls directly onto the lower and adjacent delivery belt system 26. The delivery belt system 26 is a self-contained unit having a housing 56, an endless loop conveyor belt 58, a hydraulic or electric motorized roller 60 for rotating the conveyor belt 58, and a hydraulic or electrical motor driven mulch mixing auger 62 having tines or arms 64 positioned to expand or fluff mulch material being dumped upon the conveyor belt 58, although materials other than mulch may also be processed. The housing 56 includes a floor 66, a front wall 68, a rear wall 70, a first sidewall 72, and a second sidewall 74. The controllers 76 for the operation on the conveyor 58 may be placed on the first sidewall 72 for convenience and accessibility. The conveyor belt 58 has an exit or delivery end 78 located at the last, outermost, or outside roller 60 wherein material is expelled or dumped off the conveyor belt 58. The side of the vehicle 10 associated with the delivery end 78 is referenced herein as the delivery side 80 of the vehicle 10.

To maximize volume or sizing, the material bed 24 has its sidewall 44 on the delivery side 80 positioned to extend well outside the frame rail 14 associated with the delivery side 80. Similarly, the equipment bed 28 has its sidewall or side rail 34 positioned to extend well outside the frame rail 14 associated with the delivery side 80. However, the delivery belt system 26 has its first sidewall 72 positioned above or closely adjacent the frame rail 14 associated with the delivery side 80. The delivery end 78 of the conveyor belt 58 is similarly positioned above or closely adjacent to the frame rail 14 associated with the delivery side 80. As such, it should be understood that the delivery end 78 of the conveyor belt 58 and the first sidewall 72 of the delivery belt system housing 56 associated with the delivery side 80 are positioned inboard of the adjacent sidewalls 44 and 34 of the material bed 24 and equipment bed 28, thus forming a delivery notch, notch area, or recess 82 along the delivery side 80 of the vehicle 10 to allow access to the material being expelled from the conveyor belt 58 while minimizing the encroachment of the wheelbarrow or other collection device in the roadway.

Thus, the material bed 24 has its delivery side sidewall 44 positioned a first select distance D1 laterally from the chassis 12. The equipment bed has its delivery side sidewall 34 positioned a second select distance D2 laterally from the chassis. The delivery belt system has its delivery side first sidewall 72 positioned a third select distance D3 laterally from the chassis (generally at or nearly even with the chassis). As such, the third select distance D3 is less than the first select distance D1 and less than the second select distance D2 to form the notch area 82.

In use, loose material, such as mulch or other top-dressing materials, is deposited into the material bed 24 through the open top of the material bed 24 and onto the conveyor belt 50 of conveyor 48 within the material bed 24. The vehicle 10 is then driven to the job site for the material to be delivered. Once at the job site, a wheelbarrow or other transportation device, is positioned within the notch area 82 of the delivery side 80 of the vehicle 10. The notch area 82 allows the wheelbarrow to be positioned closer to the delivery end 78 of conveyor belt 58, to minimize waste from spillage while also minimizing the encroachment of wheelbarrows and the like into the roadway.

The controller 76 is then actuated so as to selectively activate the material bed conveyor 48, the auger 62, and the conveyor belt 58 of the delivery belt system 26. The movement of the material bed conveyor 48 causes the loose material to be moved rearwardly until it falls off the conveyor 48 and through the arms 64 of the auger 62. The movement of the auger 62 causes the material to be expanded or fluffed up to maximize the volume of the loose material. The loose material falls through the auger 62 and onto the underlying conveyor 58 of the delivery belt system 26.

The delivery belt system 26 is then activated, either sequentially with or simultaneously with the activation of the conveyor 48, so that the loose material is expelled off the exit or delivery end 78 of the conveyor belt 50 and onto the underlying wheelbarrow or other equipment.

It should be understood that the positioning of the delivery belt system 26 between the material bed 24 and the equipment bed 28 places the delivery belt system 26 forward of the rear wheels 16. This placement allows the weight of the delivery belt system 26 to be more centralized for better balancing of the vehicle's weight or center of gravity. The is different from prior art vehicles that have a delivery belt system 26 mounted at the extreme rear end of the vehicle, which causes the vehicle to be tail heavy.

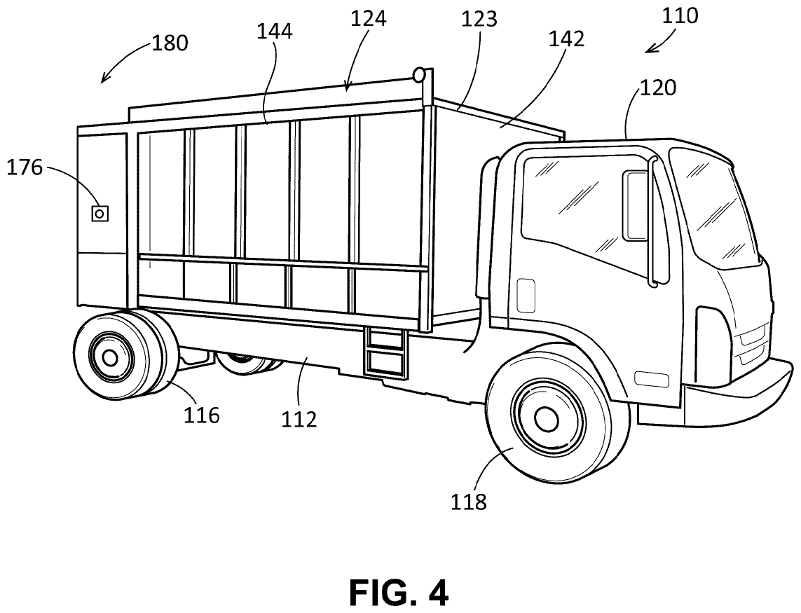

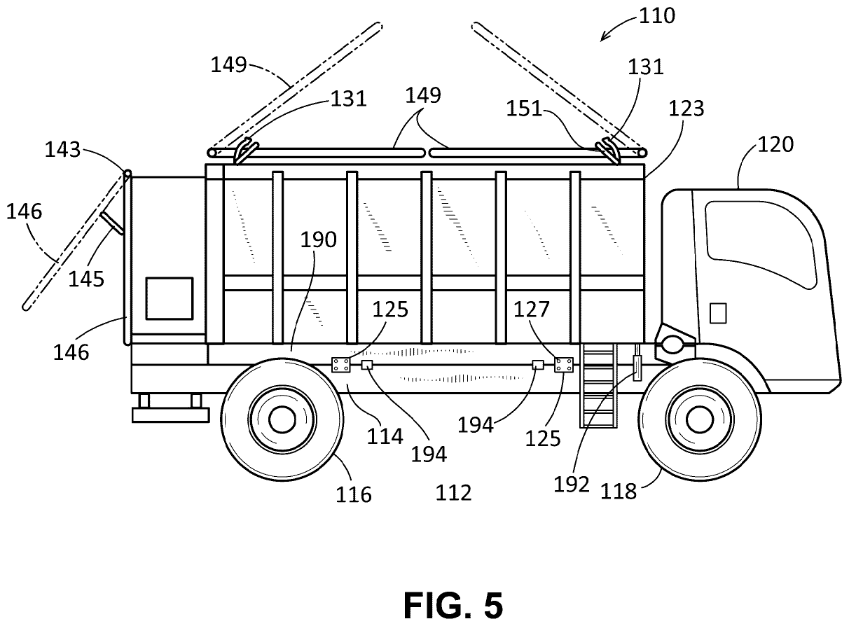

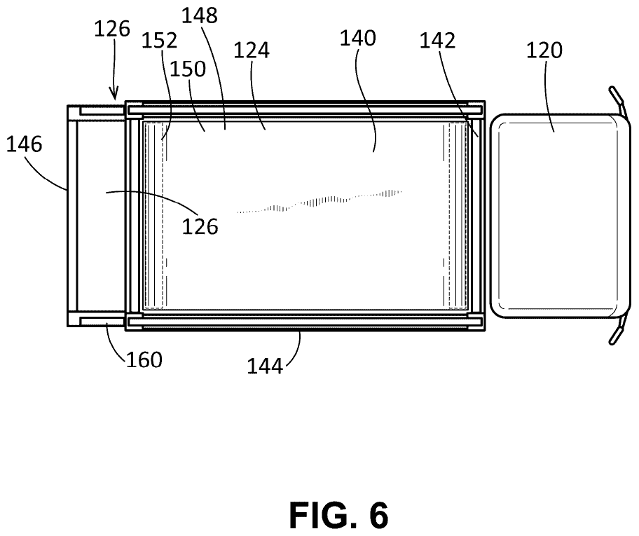

With1 reference next to FIGS. 4 through 6, there is shown a top-dressing material delivery vehicle 110 according to the present invention in another form of a truck, such as a pickup truck, utility truck, box delete truck, chassis cab truck, hook lift truck, switch and go type truck, roll off type truck, and the like, or even a trailer, referenced hereinafter simply as vehicle 110.

The vehicle 110 includes a frame or chassis 112 having longitudinal rails or beams 114. The vehicle 110 also includes the typical additional components of a truck, such as rear wheels and suspension 116, a front wheels and suspension 118, unshown rear axle, unshown drivetrain of a motor and transmission, and a passenger cab 120 positioned at the front end of the frame 112. A trailer embodiment would not include the cab or drivetrain of a truck. The cab 120 includes all the conventional components such as seats, dashboard, gauges, steering wheel, transmission shifter, etc. The cab 120 is typically positioned over the motor and transmission of the vehicle 110.

The vehicle 110 also includes a removable, modular, or detachable material bin or bed 124 mounted to frame 112 directly behind or rearward of the cab 120, the term removable or removably meaning that the material bin is easily and quickly removed through a deliberate and time efficient method such as the removal of a small number of bolts, brackets, holding pins, and the like, and does not mean the breaking, tearing or other brute force removal of the material bin. The material bin 124 includes a container or container portion 123 having therein a laterally extending (side to side) delivery belt system 126 mounted directly behind or rearward of a longitudinally extending (front to back) walking floor type conveyor 148 or other type of conventionally known conveyor or conveying system. The delivery belt system 126 may be a belted, tarped, or walking floor system that is coupled to the material bed 124 so as to be capable of moving loose material to the rear and side of the material bed 124. The forward end represents the front end of the vehicle and its components relative to the vehicle's customary forward direction, while the rearward end is the trailing end opposite from the forward end. The container 123 has top hooks 131 that enable the container to be coupled to a crane or the like to enable the container 123 to be lifted off the chassis 112 and moved.

The material bed 124 is generally an open top container having a floor 140, a front wall 142, two oppositely disposed sidewalls 144, and a rear wall 146. As an alternative, the rear wall 146 may be in the form of a pivotal door or gate having a hinge 143 located along the top edge of the door for actuation between a door open position and a door closed position through hydraulics 145 or the like. The conveyor 148 may be a walking floor type conveyor 148 is positioned over the floor 140 that is configured to move loose material within the material bed 124 to a position located at the rear of the material bed 124. The conveyor 148 may also be a movable or rollable tarp type system of other moving floor system that moves large amounts of loose material contained within the material bed 124. The material bed 124 may also include one or more top covers or top plates 149 that cover the top opening to prevent rain from contacting the loose material (mulch) within the material bed and to prevent the blowing out of the loose material (mulch) from the material bed while the vehicle is moving. The top cover or covers 149 may be coupled to hydraulics 151 to facilitate the opening and closing of the top covers 149.

The conveyor 148 includes an endless loop conveyor belt 150 that is rotated through hydraulic or electric motorized rollers 152. The conveyor belt 150 may be a chevron patterned conveyor belt that is specifically designed for moving loose material.

The delivery belt system 126 is mounted directly behind the material bed 124 so that material being moved off the conveyor belt 150 falls directly onto the lower and adjacent delivery belt system 126. The delivery belt system 126 is a self-contained unit having an endless loop conveyor belt 158, and a hydraulic or electric motorized roller 160 for rotating the conveyor belt 158. The controllers 176 for the operation on the conveyor 158 and delivery belt system 126 may be placed on the exterior of the container for convenience and accessibility. The conveyor belt 158 has an exit or delivery end 178 located at the last, outermost, or outside roller 160 wherein material is expelled or dumped off the conveyor belt 158. The side of the vehicle 110 associated with the delivery end 178 is referenced herein as the delivery side 180 of the vehicle 110 and may be located on either side or on both sides if the delivery belt system 126 may be actuated in either direction.

To maximize volume or sizing, the material bed 124 has its sidewall 144 on the delivery side 180 positioned to extend well outside the frame rail 114 associated with the delivery side 180.

In use, loose material, such as mulch or other top-dressing materials, is deposited into the material bed 124 through the open top of the material bed 124 and onto the conveyor belt 150 of conveyor 148 within the material bed 124. The vehicle 110 is then driven to the job site for the material to be delivered. Once at the job site, a wheelbarrow or other transportation device, is positioned adjacent to the delivery side 180 of the vehicle 110 at the location of the delivery end 178 of conveyor belt 158.

The controller 176 is then actuated so as to selectively activate the material bed conveyor 148 and/or the conveyor belt 158 of the delivery belt system 126. The movement of the material bed conveyor 148 causes the loose material to be moved rearwardly until it falls off the conveyor belt 150 and onto the conveyor belt 158 of the delivery belt system 126.

The delivery belt system 126 is then activated, either sequentially with or simultaneously with the activation of the conveyor 148, so that the loose material is expelled off the exit or delivery end 178 of the conveyor belt 158 and onto the underlying wheelbarrow or other equipment.

The material bin 124 or container portion 123 is configured to be easily detachable or removable from the frame or chassis 112 through metal mounting plates 125 having an upper end coupled to the material bin 124 through bolts 127 and a lower end coupled to the frame 112 or beams 114 through mounting bolts 127. The material bin 124 includes all the equipment or components necessary to move the material (mulch) from within the container portion and should be considered to be self-contained, self-standing or potentially independent from the rest of the vehicle. The term “self-contained” or “self-standing” is intended to mean that the material bin 124 and its components, such as the container portion 123, material conveyor 148 and delivery belt system 126, are contained together so that they may be easily removed from the chassis 112 as a single unit. The removability of the material bin 124 from the frame 112 through the use of lifting hooks 131 and associated lifting equipment allows the material bin 124 to easily be removed and replaced if the equipment associated with the material bin is in need or repair or replacement. The material bin 124 may also include fork lift channels designed to enable the material bin 124 to be lifted and moved in similar fashion. This allows for the associated vehicle to be outfitted with a different material bin 124 so that it may continued to be used without a prolong interruption. This also allows the material bin to be mounted to different types of trucks or vehicles to address different needs or limits in vehicle accessibility associated with the size of the vehicle or other equipment carried on the vehicle. Also, a scissor jack or other lifting device may be incorporated between the chassis and the material bin to raise and lower the material bin.

It should be understood that as an alternative to using the delivery belt system 126 for lateral expulsion of the loose material, alternatively, the rear wall (door) 146 may be swung to its open position and the conveyor 148 actuated to move the loose material (mulch) rearwardly. The constant movement of the loose material (mulch) will cause it to be pushed over the delivery belt system 126 and out the rear opening uncovered by the opening of the rear wall (door) 146. Here, the loose material may then fall directly onto the ground or into containers or wheelbarrows positioned adjacent the rear end of the vehicle 110.

As another alternative, the material bin 124 may include a peripheral frame 190 extending about at least a portion of the bottom portion of the container 123 so that the container 123 nests within the peripheral frame 190. The container 123 is coupled to the peripheral frame 190 through at least four hydraulic pistons 192 what enable the container 123 to be moved vertically relative to the peripheral frame 190. This vertical movement of the container 123 enables the container to be raised if additional clearance is needed below the container 123 to allow for placement of delivery equipment such as wheelbarrows, spreading equipment, delivery equipment, etc. Thus, the container 123 may be placed in a low position while the vehicle is moving to provide a low center of gravity or place in a high position while in operation to enable for better access of delivery equipment. The peripheral frame 190 may also allow for a more universal configuration to enable easier coupling of the material bin 124 to the vehicle frame or chassis 112, thereby also allowing from a more versatile movement of the material bin 124 between different vehicles or type of vehicles. If this occurs, safety mechanisms 194, such as hydraulic catches, hooks or pins, may be used to lock the material bin 124 to the vehicle chassis 112 to prevent relative movement therebetween.

It should be understood that as the conveyor belt 50 may operate in either direction (forward or rearward), the notched area 82 may to located on any of the four corners. As such, the material bin 124 may include both a rearward mounted delivery belt system as shown in the drawings and a forward mounted delivery belt system positioned at the front end of the material bin 124. Alternatively, the removability of the material bin 124 also allows the entire material bin to be reversed or orientable both in a forward direction and a rearward direction, i.e., the material bin 124 would have one delivery belt system but the entire material bin could be mounted in either direction so that the delivery belt system is either in the front directly behind the cab 20 or in the rear distally from the cab 20.

It thus is seen that a material delivery vehicle is now provided which overcomes problems associated with the prior art. While this invention has been described in detail with particular references to the preferred embodiments thereof, it should be understood that many modifications, additions and deletions, in addition to those expressly recited, may be made thereto without departure from the spirit and scope of the invention as set forth in the following claims.

1. 1 A top-dressing material delivery vehicle comprising:
a chassis;
a pair of rear wheels;
a pair of front wheels;
a cab mounted to said chassis, and
a material bed having a container portion having a top opening and being removably mounted to said chassis directly behind said cab, a material conveyor positioned within said container portion configured to move material within the container portion rearwardly to a delivery belt system also contained within said container portion, the material bed and its components being self-contained so as to be removable from said chassis.

2. The top-dressing material delivery vehicle of claim 1 wherein said container portion includes a pivotal rear door having a hinge for movement of said rear door between an open position and a closed position.

3. The top-dressing material delivery vehicle of claim 1 wherein said container portion includes at least one top cover movable between a first position covering said top opening and a second position uncovering said top opening.

4. The top-dressing material delivery vehicle of claim 1 wherein said container portion includes lifting hooks adjacent said top opening.

5. The top-dressing material delivery vehicle of claim 1 wherein said material bed further comprises a peripheral frame positioned at least partially about said container portion and at least one hydraulic piston coupled to said peripheral frame and said container portion to vertically move said container portion relative to said peripheral frame.

6. 1 A top-dressing material delivery vehicle comprising:
a chassis having a forward end and a rear end;
a pair of rear tires;
a pair of front tires, and
a material bed having a container having a rear opening and a top opening, said container having a bottom wall from which extends a front wall, two oppositely disposed side walls, and a pivotal rear door for pivotal movement between a closed position covering said rear opening and an open position uncovering said rear opening, said material bed also including a laterally extending delivery belt system mounted to said container closely adjacent to said rear door and a longitudinally extending material conveyor extending from said front wall to said delivery belt system, said material conveyor being configured to move loose material rearwardly towards said rear door and over said delivery belt system so that the loose material may exit through said rear opening when said rear door is located at its open position.

7. The top-dressing material delivery vehicle of claim 6 wherein said material bed is removably coupled to said chassis.

8. The top-dressing material delivery vehicle of claim 6 wherein said container, said delivery belt system and said material conveyor are self-contained, and wherein said material bed is removably coupled to said chassis.

9. The top-dressing material delivery vehicle of claim 6 wherein said material bed includes at least one top cover movable between a first position covering said top opening and a second position uncovering said top opening.

10. The top-dressing material delivery vehicle of claim 7 wherein said container portion includes lifting hooks adjacent said top opening.

11. The top-dressing material delivery vehicle of claim 8 wherein said container portion includes lifting hooks adjacent said top opening.

12. The top-dressing material delivery vehicle of claim 6 wherein said material bed further comprises a peripheral frame positioned at least partially about said container and at least one hydraulic piston coupled to said peripheral frame and said container to vertically move said container relative to said peripheral frame.

13. 1 A top-dressing material delivery bin mountable to a vehicle chasses, the top-dressing material delivery bin comprising:
a material bed having a container portion having a top opening and being removably mountable to a vehicle chassis through mounting plates, a material conveyor positioned within said container portion configured to move material within the container portion rearwardly to a delivery belt system also contained within said container portion, the material bed and its components being self-contained so as to be removable from said chassis.

14. The top-dressing material delivery bin of claim 13 wherein said container portion includes a pivotal rear door having a hinge for movement of said rear door between an open position and a closed position.

15. The top-dressing material delivery bin of claim 13 wherein said container portion includes at least one top cover movable between a first position covering said top opening and a second position uncovering said top opening.

16. The top-dressing material delivery bin of claim 13 wherein said container portion includes lifting hooks adjacent said top opening.

17. The top-dressing material delivery vehicle of claim 13 wherein said material bed further comprises a peripheral frame positioned at least partially about said container portion and at least one hydraulic piston coupled to said peripheral frame and said container portion to vertically move said container portion relative to said peripheral frame.

18. 1 A top-dressing material delivery bin mountable to a vehicle chassis, the top-dressing material delivery bin comprising:
a material bed having a container having a rear opening and a top opening, said container having a bottom wall from which extends a front wall, two oppositely disposed side walls, and a pivotal rear door for pivotal movement between a closed position covering said rear opening and an open position uncovering said rear opening, said material bed also including a laterally extending delivery belt system mounted to said container closely adjacent to said rear door and a longitudinally extending material conveyor extending from said front wall to said delivery belt system, said material conveyor being configured to move loose material rearwardly towards said rear door and over said delivery belt system so that the loose material may exit through said rear opening when said rear door is located at its open position.

19. The top-dressing material delivery vehicle of claim 18 wherein said material bed is removably coupled to a vehicle chassis.

20. The top-dressing material delivery vehicle of claim 18 wherein said container, said delivery belt system and said material conveyor are self-contained, and wherein said material bed is removably coupled to a vehicle chassis.

21. The top-dressing material delivery vehicle of claim 18 wherein said material bed includes at least one top cover movable between a first position covering said top opening and a second position uncovering said top opening.

22. The top-dressing material delivery vehicle of claim 19 wherein said container portion includes lifting hooks adjacent said top opening.

23. The top-dressing material delivery vehicle of claim 20 wherein said container portion includes lifting hooks adjacent said top opening.

24. The top-dressing material delivery vehicle of claim 18 wherein said material bed further comprises a peripheral frame positioned at least partially about said container portion and at least one hydraulic piston coupled to said peripheral frame and said container portion to vertically move said container portion relative to said peripheral frame.
